(19) United States
(12) Patent Application Publication
(10) Pub. No.: US 2005/0010586 A1
(43) Pub. Date: Jan. 13, 2005

(54) Server machine, client machine, server/client system, server program and client program

(75) Inventor: Nobutaka Ishidera, Inagi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/914,224

(22) Filed: Aug. 10, 2004

Related U.S. Application Data
(63) Continuation of application No. PCT/JP02/01601, filed on Feb. 22, 2002.

(51) Int. Cl. G06F 17/00

(52) U.S. Cl. 707/100

(57) ABSTRACT

The present invention relates to a server/client system, a server machine and a client machine constituting the server/client system, and the like. An object of the present invention is to prevent a failure from occurring in the client machine. The states of components of the client machine are monitored, and when a failure is found in a component, the server machine is notified of the failure. The server machine then offers a replacement for the failed component to the client machine.

### TECHNICAL FIELD

The present invention relates to a server machine that is linked to a client machine via a communication line and provides information to the client machine, a client machine that is linked to a server machine via a communication line and receives information from the server machine, a server/client system including the server machine and the client machine, a server program that makes a computer operate as the server machine, and a client program that makes a computer operate as the client machine.

### BACKGROUND ART

Many personal computers and other devices require users to have special knowledge for comfortable operation. However, for example, with the recent popularization of the Internet and e-mail, personal computers have become popular among ordinary people without special knowledge. Thus, manufacturers or other experts are required to offer supports that enable those people to use personal computers comfortably.

However, conventionally, support offering starts when the user of a personal computer requests the support. It is difficult for an ordinary user without enough special knowledge to predict possible failures of his/her personal computer, such as depletion of batteries and a failure of the hard disk. Therefore, the user can request no support before a trouble or failure occurs actually. Furthermore, even after a failure actually occurs, the user cannot determine the part where the failure occurs, and thus, even if the user makes a support request, it often takes a long time to recover from the failure. Besides, a somewhat minor failure is likely to be missed and often leads to a serious trouble as a result of the personal computer remaining in use in spite of the failure. For example, if such a failure occurs in the hard disk, unrecoverable data including documents created by the user is critically lost.

Although manufacturers offer various kinds of information about replacement parts or the like, it is general information which is offered to many users. Accordingly, an individual user, who cannot predict failures, probably cannot know what part of his/her personal computer should be replaced with new one and when to carry out the replacement.

### DISCLOSURE OF THE INVENTION

In view of such circumstances, an object of the present invention is to provide a server machine that can provide appropriate information for each user at an adequate timing, a client machine that can receive such appropriate information at an adequate timing, a server/client system having such a server machine and such a client machine, a server program that makes a computer operate as such a server machine, and a client program that makes a computer operate as such a client machine.

In order to attain the object described above, a server machine according to the present invention is a server machine that is connected to a client machine via a communication line and provides information for the client machine, characterized in that the server machine comprises:
an information receiving section that receives hardware information that indicates the state of the hardware of the client machine via the communication line;
a catalog retrieving section that retrieves catalog information about a replacement for a part of the client machine or for the client machine itself based on the hardware information about the client machine received at the information receiving section; and
a catalog transmitting section that transmits the catalog information retrieved by the catalog retrieving section to the client machine via the communication line.

Preferably, in the server machine according to the present invention described above, the information receiving section receives information about deterioration of a part of the client machine or of the client machine itself as the hardware information from the client machine, and the catalog retrieving section retrieves catalog information about a replacement for the deteriorated part of the client machine or for the deteriorated client machine itself based on the hardware information about the client machine received at the information receiving section.

The server machine according to the present invention receives the hardware information about the client machine, such as the hardware information indicating deterioration of a part of the client machine or of the client machine itself, from the client machine, retrieves the catalog information about a replacement for the part of the client machine or for the client machine itself based on the hardware information, and transmits the catalog information to the client machine. By referring to the catalog information, the client machine can determine the part that is preferably to be replaced with a new one at that point in time.

The server machine according to the present invention described above may have a catalog database storing catalog information, and the catalog retrieving section may search the catalog database. Alternatively, the communication line may have another machine that provides catalog information connected thereto besides the server machine, and the catalog retrieving section may inquire of the other machine whether it retains desired catalog information to acquire the desired catalog information.

Preferably, in the server machine according to the present invention described above, the catalog retrieving section retrieves catalog information from a plurality of locations, the catalog information including price information, and the catalog retrieving section retrieves desired catalog information by referring to the price information in the catalog information.

Thus, the client machine can know a replacement at the lowest price, for example.

Furthermore, the server machine according to the present invention described above preferably comprises a purchase offer receiving section that receives a purchase offer for a replacement listed in the catalog information via the communication line from the client machine to which the catalog information has been transmitted.

With the purchase offer receiving section, the server machine can provide both the information offering service and the replacement selling service.

In order to attain the object described above, a client machine according to the present invention is a client machine that is connected to a server machine via a communication line and receives information provided by the server machine, characterized in that the client machine comprises:
a monitoring section that monitors the client machine and acquires hardware information that indicates the state of the hardware of the client machine;
an information transmitting section that transmits the hardware information acquired by the monitoring section to the server machine via the communication line;
a catalog receiving section that receives catalog information about a replacement for a part of the client machine or for the client machine itself that is transmitted from the server machine in response to the hardware information transmitted from the information transmitting section; and
a catalog outputting section that outputs the catalog information received at the catalog receiving section.

The catalog outputting section may be a one that outputs (displays) the catalog on a display screen or prints the catalog with a printer. The catalog outputting section may output the catalog in any form that can be recognized by the user of the client machine.

Since the client machine according to the present invention monitors the client machine, acquires the hardware information indicating the state of the hardware of the client machine and transmits the hardware information to the server machine, it can receive catalog information suitable for the state of the hardware of the client machine, so that any part in which a failure is likely to occur can be known before the failure occurs, and measures, such as component replacement, can be taken in advance.

Preferably, the client machine according to the present invention described above further comprises a purchase offering section that conducts a purchase offering procedure for a replacement listed in the catalog information received at the catalog receiving section.

With the purchase offering section, the client machine can accomplish a purchase offer via the communication line, so that it can readily purchase a replacement listed in the catalog information.

In order to attain the object described above, a server/client system according to the present invention is a server/client system having a server machine for providing information and a client machine for receiving information from the server, which are connected to each other via a communication line, characterized in that the server machine comprises:
an information receiving section that receives hardware information that indicates the state of the hardware of the client machine via the communication line;
a catalog retrieving section that retrieves catalog information about a replacement for a part of the client machine or for the client machine itself based on the hardware information about the client machine received at the information receiving section; and

a catalog transmitting section that transmits the catalog information retrieved by the catalog retrieving section to the client machine via the communication line, and
the client machine comprises:
a monitoring section that monitors the client machine and acquires hardware information that indicates the state of the hardware of the client machine;
an information transmitting section that transmits the hardware information acquired by the monitoring section to the server machine via the communication line;
a catalog receiving section that receives catalog information about a replacement for a part of the client machine or for the client machine itself that is transmitted from the server machine in response to the hardware information transmitted from the information transmitting section; and
a catalog outputting section that outputs the catalog information received at the catalog receiving section.

In addition, in order to attain the object described above, a server program according to the present invention is a server program that is executed in a computer connected to a client machine via a communication line and makes the commuter operate as a server machine that provides information to the client machine, characterized in that the server machine makes the computer operate as a server machine comprising:
an information receiving section that receives hardware information that indicates the state of the hardware of the client machine via the communication line;
a catalog retrieving section that retrieves catalog information about a replacement for a part of the client machine or for the client machine itself based on the hardware information about the client machine received at the information receiving section; and
a catalog transmitting section that transmits the catalog information retrieved by the catalog retrieving section to the client machine via the communication line.

Preferably, in the server program according to the present invention described above, the information receiving section receives information about deterioration of a part of the client machine or of the client machine itself as the hardware information from the client machine, and the catalog retrieving section retrieves catalog information about a replacement for the deteriorated part of the client machine or for the deteriorated client machine itself based on the hardware information about the client machine received at the information receiving section.

The server machine may have a catalog database storing catalog information, and the catalog retrieving section may search the catalog database. Alternatively, the communication line may have another machine that provides catalog information connected thereto besides the server machine, and the catalog retrieving section may inquire of the other machine whether it retains desired catalog information to acquire the desired catalog information.

In addition, in the server program according to the present invention described above, it is preferably that the catalog retrieving section retrieves catalog information from a plurality of locations, the catalog information including price information, and the catalog retrieving section retrieves desired catalog information by referring to the price information in the catalog information.

Furthermore, the server program according to the present invention described above preferably makes the computer operate as the server machine further comprising a purchase offer receiving section that receives a purchase offer for a replacement listed in the catalog information via the communication line from the client machine to which the catalog information has been transmitted.

Furthermore, in order to attain the object described above, a client program according to the present invention is a client program that is executed in a computer connected to a server machine via a communication line and makes the computer operate as a client machine that receives information provided by the server machine, characterized in that the client program makes the computer operate as a client machine comprising:
a monitoring section that monitors the client machine and acquires hardware information that indicates the state of the hardware of the client machine;
an information transmitting section that transmits the hardware information acquired by the monitoring section to the server machine via the communication line;
a catalog receiving section that receives catalog information about a replacement for a part of the client machine or for the client machine itself that is transmitted from the server machine in response to the hardware information transmitted from the information transmitting section; and
a catalog outputting section that outputs the catalog information received at the catalog receiving section.

The client program according to the present invention described above preferably makes the computer operate as the client machine further comprising a purchase offering section that conducts a purchase offering procedure for a replacement listed in the catalog information received at the catalog receiving section.

### BRIEF DESCRIPTION OF THE DRAWINGS

FIG. 1 is a schematic view of a server/client system.

FIG. 2 shows a hardware configuration of a computer.

FIG. 3 is a schematic diagram showing a server program according to an embodiment of the present invention.

FIG. 4 is a schematic diagram showing a client program according to an embodiment of the present invention.

FIG. 5 is a functional block diagram of a server machine according to an embodiment of the present invention.

FIG. 6 is a functional block diagram of a client machine according to an embodiment of the present invention.

FIG. 7 shows a server/client system according to an embodiment of the present invention.

FIG. 8 shows an example of a dialog box, which is shown as one block in FIG. 7.

FIG. 9 is a flowchart concerning a hardware monitoring program resident in a user PC shown in FIG. 7.

FIG. 10 shows a format of information saved in a trouble/failure database shown in FIG. 7.

FIG. 11 shows a list of specific ones of “Device”.

FIG. 12 shows a list of specific ones of “Status”.

FIG. 13 shows a flow of a process executed in a server shown in FIG. 7.

FIG. 14 shows a data structure of information stored in a database in the server.

FIG. 15 shows specific examples of the information stored in the database in the server.

FIG. 16 shows a process flow after the dialog box is displayed.

FIG. 17 shows an example of a web page A shown in FIG. 16.

FIG. 18 shows an example of a web page B shown in FIG. 16.

FIG. 19 shows an example of a web page C shown in FIG. 16.

FIG. 20 shows an example of a web page D shown in FIG. 16.

FIG. 21 shows an example of a web page E shown in FIG. 16.

FIG. 22 shows a piece of information in the database in the server.

FIG. 23 shows a catalog selection process (see FIG. 7) executed in the server when CGI shown in FIG. 22 is activated.

FIG. 24 shows an example of a database in the server that supports a video cassette recorder capable of hard disk recording.

### BEST MODE FOR CARRYING OUT THE INVENTION

Now, embodiments of the present invention will be described.

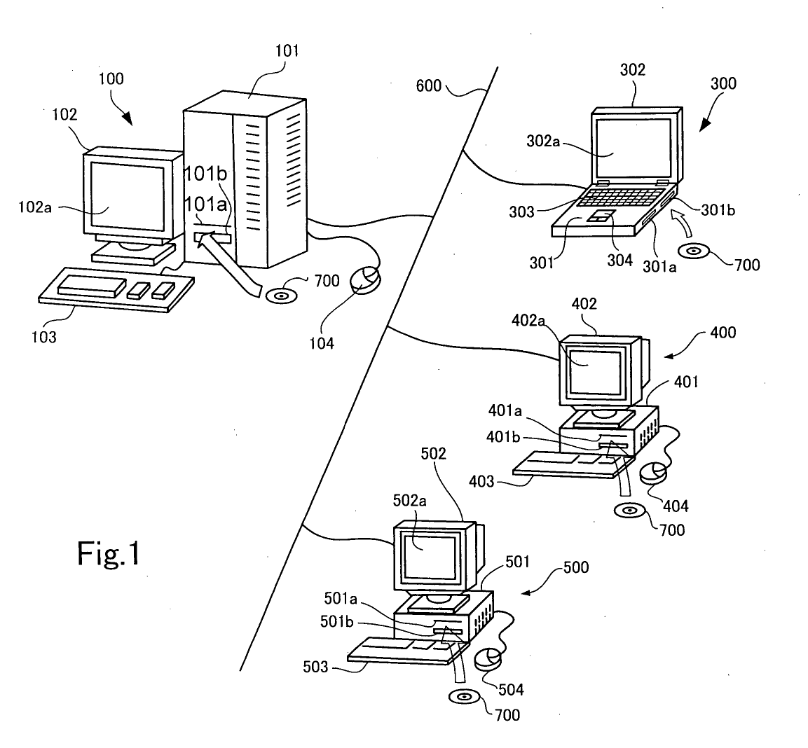

FIG. 1 is a schematic view of a server/client system.

FIG. 1 shows a computer 100 that operates as a server machine, three computers 300, 400 and 500 that are linked to the computer 100 via a communication line 600 and operate as client machines, by way of illustration. The communication line 600 may be the Internet, a local area network (LAN) or a wide area network (WAN).

A server program is installed in the computer 100 to make the computer operate as a server machine, and a client program is installed in the three computers 300, 400 and 500 to make the computers operate as client machines.

In general, the computers 100, 300, 400 and 500 may be computers called workstations or personal computers. In the system shown in FIG. 1, the computer 300 is a so-called notebook personal computer.

The computer 100 (300, 400, 500) comprises: a main unit 101 (301, 401, 501) incorporating a central processing unit (CPU), a random access memory (RAM), a hard disk, a communication board and the like; a display unit 102 (302, 402, 502) that displays an image or character string on a display screen 102a (302a, 402a, 502a) in response to an instruction from the main unit 101 (301, 401, 501); a keyboard 103 (303, 403, 503) for inputting a user instruction to the computer 100 (300, 400, 500); and a pointing device (a mouse 104, 404 or 504 for the computer 100, 400 or 500, respectively, and a track pad 304 for the computer 300) that points at an arbitrary position on the display screen 102a (302a, 402a, 502a) thereby inputting an instruction corresponding to an icon or the like displayed at the pointed position.

Viewed from the outside, the main unit 101 (301, 401, 501) further comprises a flexible disk loading slot 101a (301a, 401a, 501a) for receiving a flexible disk (not shown) and a CD-ROM loading slot 101b (301b, 401b, 501b) for receiving a CD-ROM 700. Furthermore, the main unit 101 (301, 401, 501) incorporates a flexible disk drive for driving and accessing the flexible disk loaded through the slot 101a (301a, 401a, 501a) and a CD-ROM drive for driving and accessing the CDS-ROM 700 loaded through the slot 101b (301b, 401b, 501b).

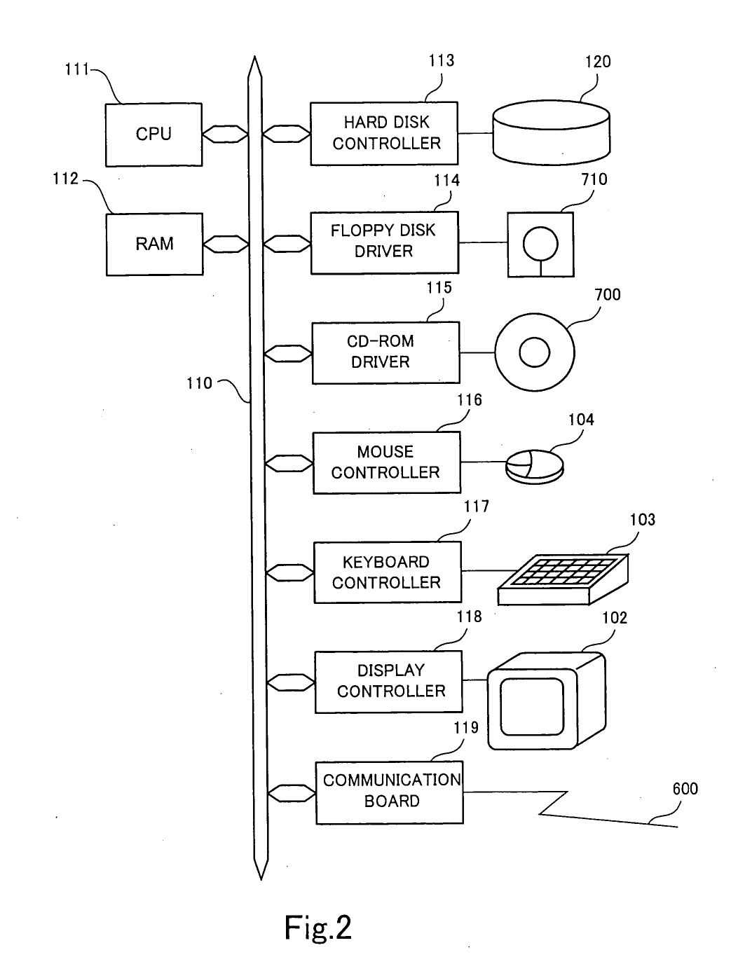

FIG. 2 shows a hardware configuration of the computer schematically shown in FIG. 1. While the computer 100 will be described as a representative, the other computers 300, 400 and 500 have essentially the same configuration.

The hardware configuration diagram of FIG. 2 shows a CPU 111, a RAM 112, a hard disk controller 113, a flexible disk drive 114, a CD-ROM drive 115, a mouse controller 116, a keyboard controller 117, a display controller 118 and a communication board 119, which are interconnected via a bus 110.

As described with reference to FIG. 1, the flexible disk driver 114 and the CD-ROM drive 115 are to access a flexible disk 710 and the CD-ROM 700 loaded through the flexible disk loading slot 101a and the CD-ROM loading slot 101b, respectively. The communication board 119 is connected to the communication line 600.

In addition, FIG. 2 shows a hard disk 120 accessed by the hard disk controller 113, the mouse 104 controlled by the mouse controller 116, the keyboard 103 controlled by the keyboard controller 117, and the CRT display 102 controlled by the display controller 118.

The computer 300, which is a notebook computer, has a so-called smart battery mounted thereon and can run for some time only on the power from the smart battery. The smart battery is a secondary battery that can monitor itself and recognize the degree of depletion of itself.

Through the CD-ROM loading slot 101b (301b, 401b, 501b) of the computer 100 (300, 400, 500), the CD-ROM 700, which is a server program storage medium or client program storage medium that stores a server program or client program described later, is loaded. The server program stored in the CD-ROM 700 is installed in the computer 100 to make the computer 100 operate as a server machine, and the client program stored in the CD-ROM 700 is installed in the three computers 300, 400 and 500 to make the computers operate as client machines.

However, the server program and the client program may be factory-installed in the computer 100 and the computers 300, 400 and 500, respectively, instead of using CD-ROMs. Alternatively, the client program may be stored in the computer 100 (server machine) or another device and transmitted to the computers 300, 400 and 500 via the communication line 600. Alternatively, the client program may be recorded in a flexible disk or another portable storage medium, for example, and read and uploaded to the computers 300, 400 and 500.

Now, a server program according to an embodiment of the present invention and a client program according to an embodiment of the present invention will be described.

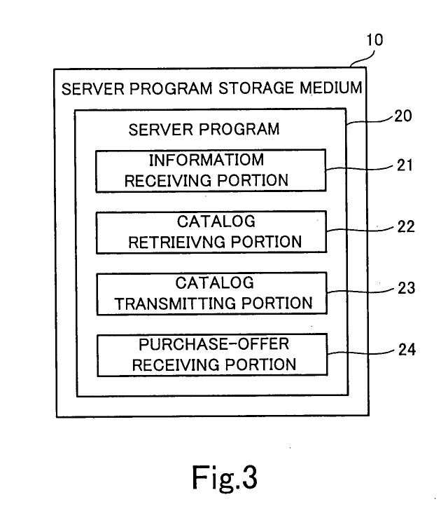

FIG. 3 is a schematic diagram showing a server program according to an embodiment of the present invention.

A server program 20 is stored in a server program storage medium 10. The server program storage medium 10 represents a CD-ROM storing the server program 20, the hard disk 120 (see FIG. 2) of the computer 100 shown in FIG. 1 that stores the server program 20 installed from a CD-ROM or the like, or the like.

The server program 20 is installed in the computer 100 shown in FIG. 1 and executed therein to make the computer 100 operate as the server machine. The server program 20 comprises an information receiving portion 21, a catalog retrieving portion 22, a catalog transmitting portion 23 and a purchase-offer receiving portion 24.

The information receiving portion 21 is to receive, via the communication line 600 (see FIG. 1), hardware information about the state of hardware of each of the computers 300, 400 and 500 shown in FIG. 1 operating as the client machine. In this embodiment, the hardware information is that about deterioration of the components of each client machine (computer) or deterioration of the client machine (computer) itself, in particular.

The catalog retrieving portion 22 is to retrieve catalog information about replacements for the components of the client machine or a replacement for the client machine itself based on the hardware information about the client machine received at the information receiving portion 21.

In this embodiment, since the hardware information is that about deterioration of the components of the client machine or deterioration of the client machine itself, the catalog retrieving portion 22 retrieves catalog information about a replacement for a deteriorated component of the client machine or a replacement for the deteriorated client machine itself, based on the hardware information about the client machine received at the information receiving portion 21.

The server machine (computer 100 shown in FIG. 1) may have a catalog database storing catalog information, and the catalog retrieving portion 22 may search the catalog database. Alternatively, besides the server machine (computer 100), a machine which provides catalog information may be connected to the communication line 600, and the catalog retrieving portion 22 may inquire of the machine whether it retains required catalog information and acquire the required catalog information if it retains it. Alternatively, the two approaches may be used in combination.

Furthermore, the catalog retrieving portion 22 may retrieve catalog information from plural locations, the catalog information may include price information, and the catalog retrieving portion 22 may retrieve desired catalog information by referring to the price information in the catalog information.

The catalog information retrieved by the catalog retrieving portion 22 as described above is transmitted by the catalog transmitting portion 23 via the communication line 600 to the client machine (any of the computers 300, 400 and 500 shown in FIG. 1) that transmitted the hardware information on which the catalog information retrieval was based.

The purchase-offer receiving portion 24 is to receive a purchase offer for a replacement listed in the catalog information from the client machine, to which the catalog information was transmitted, via the communication line.

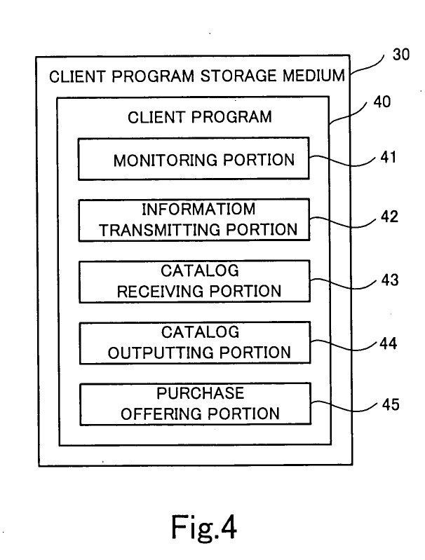

FIG. 4 is a schematic diagram showing a client program according to an embodiment of the present invention.

A client program 40 is stored in a client program storage medium 30. As with the server program storage medium 10 shown in FIG. 3, the client program storage medium 30 represents a CD-ROM storing the client program 40, the hard disk of the computer 300, 400 or 500 shown in FIG. 1 that stores the client program 40 installed from a CD-ROM or the like, or the like.

The client program 40 is installed in each of the computers 300, 400 and 500 shown in FIG. 1 to make the computers 300, 400 and 500 operate as the client machines. The client program 40 comprises a monitoring portion 41, an information transmitting portion 42, a catalog receiving portion 43, a catalog outputting portion 44 and a purchase offering portion 45.

The monitoring portion 41 is to monitor the client machine thereof and acquire hardware information about the state of hardware of the client machine. The hardware information acquired by the monitoring portion 41 is transmitted to the server machine by the information transmitting portion 42 via the communication line.

The catalog receiving portion 43 is to receive catalog information about replacements for the components of the client machine or a replacement for the client machine itself, which is transmitted from the server machine in response to transmission of the hardware information by the information transmitting portion 42. The catalog information received at the catalog receiving portion 43 is output by the catalog outputting portion 44.

The catalog outputting portion 44 can output the catalog information in any form that allows the client machine to recognize the content of the catalog information. However, in this embodiment, a display based on the catalog information is provided on the display screen 302a, (402a, 502a) of the client machine 300 (400, 500) in FIG. 1.

In addition, the purchase offering portion 45 is to conduct a purchase offer procedure for a replacement listed on the catalog information received at the catalog receiving portion 43.

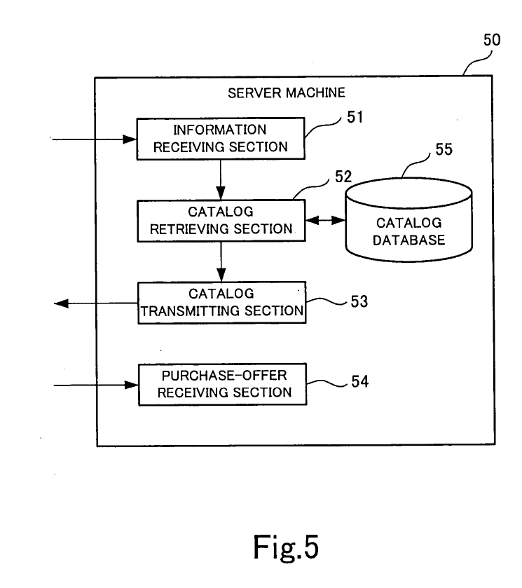

FIG. 5 is a block diagram showing a server machine according to an embodiment of the present invention.

A server machine 50 shown in FIG. 5 is constructed in the computer 100 shown in FIG. 1 by installing and executing the server program 20 shown in FIG. 3 in the computer 100.

The server machine 50 comprises an information receiving section 51, a catalog retrieving section 52, a catalog transmitting section 53 and a purchase-offer receiving section 54.

The server machine 55 has a catalog database 55 storing catalog information, and the catalog retrieving section 52 searches the catalog database 55 in the server machine 55. However, the catalog database 55 may be included in a server machine (not shown) connected to the communication line 600 (see FIG. 1) other than the server machine 50, and the catalog retrieving section 52 may inquire of the external server machine whether it retains required catalog information.

The information receiving section 51, the catalog retrieving section 52, the catalog transmitting section 53 and the purchase-offer receiving section 54 of the server machine 50 correspond to the information receiving portion 21, the catalog retrieving portion 22, the catalog transmitting portion 23 and the purchase-offer receiving portion 24 of the server program 20, respectively. However, the sections 51 to 54 of the server machine 50 shown in FIG. 5 are constituted by combinations of the hardware of the computer 100 shown in FIG. 1 and the software running in the computer 100, while the portions 21 to 24 of the server program 20 shown in FIG. 3 are constituted only by the application program, of the hardware and the software.

The sections 51 to 54 of the server machine 50 shown in FIG. 5 operate the same as the portions 21 to 24 of the server program 20 shown in FIG. 3 installed and executed in the computer 100 shown in FIG. 1, and redundancy of description of the operations will be omitted herein.

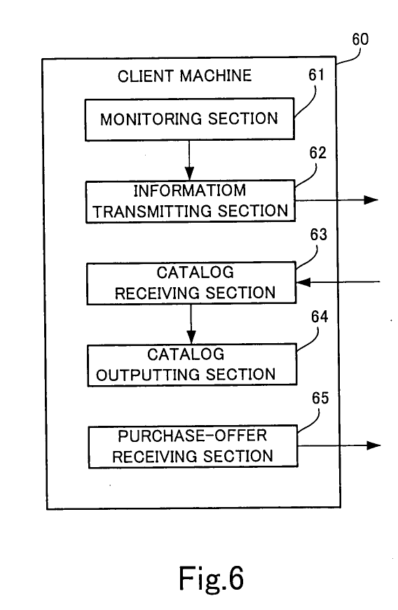

FIG. 6 is a functional block diagram of a client machine according to an embodiment of the present invention.

A client machine 60 shown in FIG. 6 is constructed in the computer 300 shown in FIG. 1 by installing and executing the client program 40 shown in FIG. 4 in the computer 300 (the same holds true with the computers 400 and 500, but the computer 300 will be described here as a representative).

The client machine 60 comprises a monitoring section 61, an information transmitting section 62, a catalog receiving section 63, a catalog outputting section 64 and a purchase offering section 65. The monitoring section 61, the information transmitting section 62, the catalog receiving section 63, the catalog outputting section 64 and the purchase offering section 65 of the client machine 60 correspond to the monitoring portion 41, the information transmitting portion 42, the catalog receiving portion 43, the catalog outputting portion 44 and the purchase offering portion 45 of the client program 40 shown in FIG. 4, respectively. However, the sections 61 to 65 of the client machine 60 shown in FIG. 6 are constituted by combinations of the hardware of the computer 300 (as a representative) shown in FIG. 1 and the software running in the computer 300, while the portions 41 to 45 of the client program 40 shown in FIG. 4 are constituted only by the application program, of the hardware and the software.

As with the server machine 50 shown in FIG. 5, the sections 61 to 65 of the client machine 60 shown in FIG. 6 operate the same as the portions 41 to 45 of the client program 40 shown in FIG. 4 installed and executed in the computer 300 shown in FIG. 1, and redundancy of description of the operations will be omitted herein.

Now, a further embodiment of the present invention will be described.

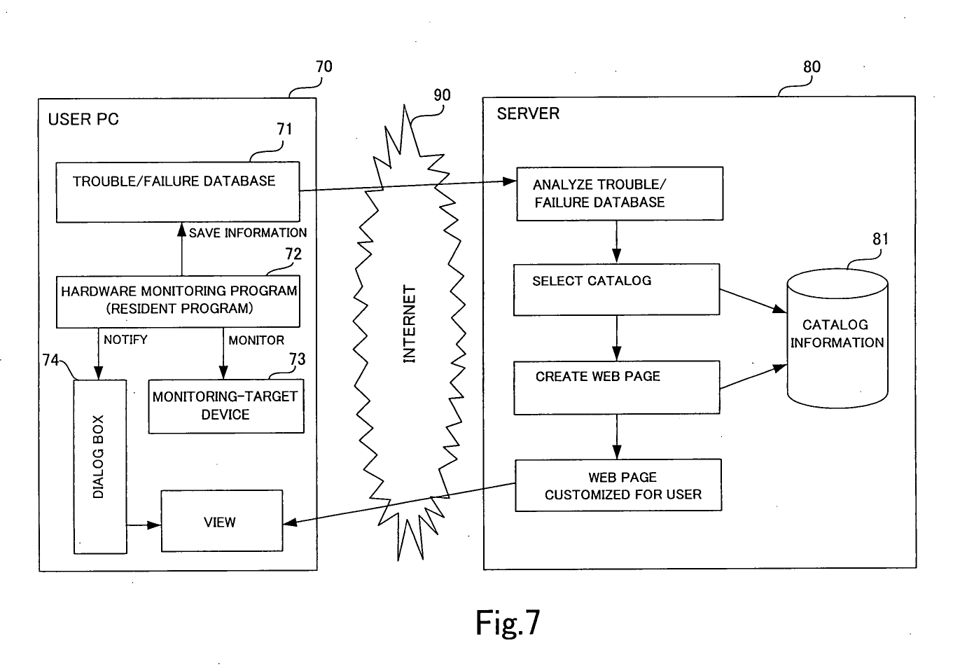

FIG. 7 shows a server/client system according to an embodiment of the present invention.

A user PC (personal computer) 70 is an example of the client machine according to the present invention, and FIG. 7 shows only one user PC as a representative. The user PC 70 is connected to a server 80 via the Internet 90. The server 80 is an example of the server machine according to the present invention, and the Internet 90 is an example of the communication line referred to in the present invention.

A hardware monitoring program 72, which is an example of the client program according to the present invention, is installed in the user PC 70. The hardware monitoring program 72 is automatically activated when the user PC 70 is activated and resides in the memory.

The hardware monitoring program 72 resident in the memory monitors a monitoring-target device 73 (a battery or a hard disk, for example) in the user PC 70 for an abnormality (depletion of the battery or a seek error in the hard disk, for example).

If the hardware monitoring program 72 detects an abnormality in the monitoring-target device 73, the hardware monitoring program 72 saves the information about the detected abnormality (which is an example of the hardware information referred to in the present invention) in a trouble/failure database 71 and displays a dialog box 74 notifying the detection of the abnormality to be viewed by the user.

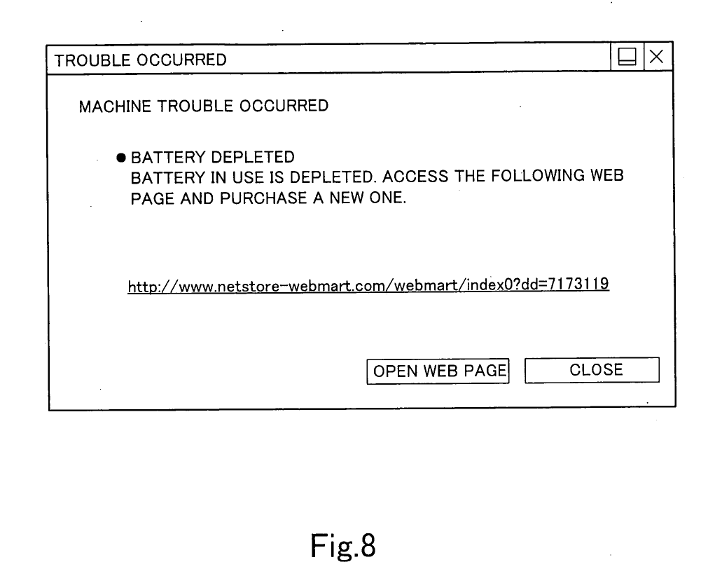

FIG. 8 shows an example of the dialog box 74, which is shown as one block in FIG. 7.

The dialog box shown in FIG. 8 is a one displayed when the battery is depleted. In the dialog box, an URL to be accessed to address the detected abnormality is described. By clicking the button “Open Web Page”, the user can open the web site specified by the URL in a browser.

Once the user opens the web site specified by the URL in a browser, the browser notifies the server 80 via the Internet 90 about the content of the trouble/failure database 71.

The server 80 analyzes the received content of the trouble/failure database to identify the trouble occurring in the user PC 70. Then, the server 80 searches a catalog database 81 storing catalog information and creates a web page including a catalog of replacements for the troubled device for sale, and the user PC 70 is notified of the creation of the web page thus customized for the user through the browser.

In response to the notification, the user PC 70 accesses the created web page, and then, the user can view the catalog of replacements for the troubled device and conduct the purchase procedure for a desired replacement.

Thus process enables the user to determine the troubled device, check replacements therefor and purchase a desired one in the stage where it is otherwise difficult to detect the trouble (a stage where the battery depletion begins, but any recognizable trouble has not occurred, for example). Thus, it is possible to avoid occurrence of recognizable troubles.

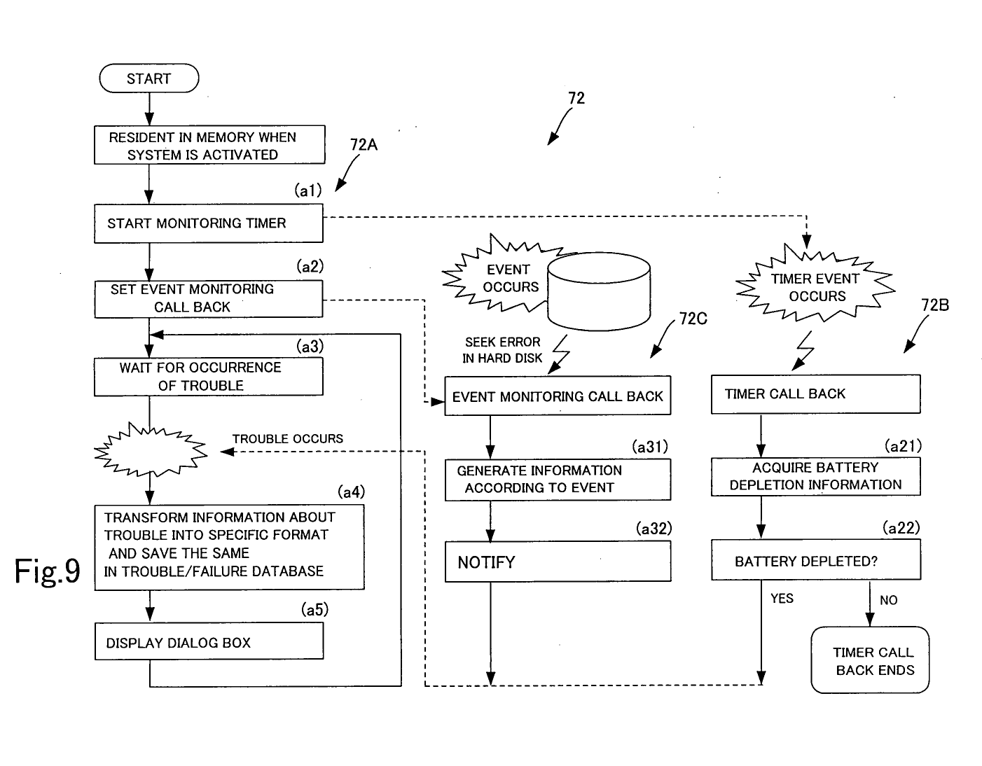

FIG. 9 is a flowchart concerning the hardware monitoring program 72 resident in the user PC 70 shown in FIG. 7.

The hardware monitoring program 72 comprises a hardware monitoring main program 72A, a timer call back 72B activated in response to occurrence of a timer event, and an event monitoring call back 72C activated in response to occurrence of an event other than the timer event. While FIG. 9 shows one timer call back 72B and one event monitoring call back 72C, they are representatives, and any number of timer call backs 72B and event monitoring call backs 72C may exist.

The hardware monitoring program 72 is resident in the memory when the user PC system is activated. The hardware monitoring main program 72A starts a monitoring timer (step a1), set an event monitoring call back (step a2) and waits for occurrence of a trouble (step a3). Once the monitoring timer is started in step al, timer events occur at predetermined intervals, for example, every one minute, to activate the timer call back 72B. Then, in this embodiment, information about battery depletion is acquired (step a21), and it is determined whether the battery is depleted or not (step a22). If the battery is not depleted, the timer call back is ended, and if the battery is depleted, the hardware monitoring main program 72A is notified of the trouble.

Besides, once the event monitoring call back is set in step a2, the event monitoring call back 72C is activated in response to occurrence of a seek error in this example, and information associated with the event (the seek error in the hard disk in this example) is generated (step a31). The hardware monitoring main program 72A is notified of the generated information.

Upon being notified of the occurrence of the trouble, the hardware monitoring main program 72A transforms the information about the trouble into a specific format and saves the transformed information in the trouble/failure database 71 (see FIG. 7) (step a4), notifies the user of the occurrence of the trouble by opening the dialog box 74 (see FIGS. 7 and 8) (step a5), and enters the waiting state again (step a3). By repeating this process, the monitoring-target device 73 in the user PC 70 shown in FIG. 7 is monitored.

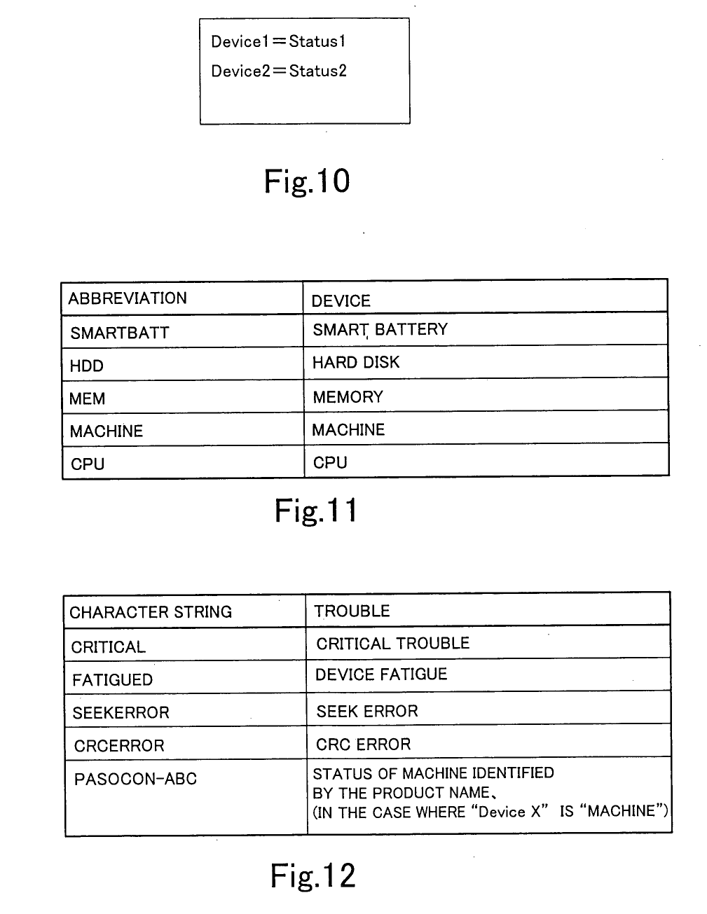

FIG. 10 shows a format of the information saved in the trouble/failure database 71 shown in FIG. 7. FIG. 11 shows a list of specific ones of “Device”, and FIG. 12 shows a list of specific ones of “Status”.

As shown in FIG. 10, the trouble/failure database 71 stores information in the format of “Device=Status”. The “Device” represents a monitoring-target device as shown in FIG. 11, and the “Status” represents the type of the trouble occurring in the monitoring-target device as shown in FIG. 12.

FIG. 10 abstractly shows “Device 1=Status 1” and “Device 2=Status 2”. However, actual descriptions include “SMARTBATT=FATIGUED” and “HDD=SEEKERROR”, for example. The description “SMARTBATT=FATIGUED” means that the smart battery suffers a device fatigue (or it is deteriorated), and the description “HDD=SEEKERROR” means that a seek error occurs in the hard disk. A description “MACHINE=PASOCPN-ABC” means that the computer serving as the user PC 70 in FIG. 7 is a one named PASOCPN-ABC and is considerably worn out and totally deteriorated. The deterioration level of the entire user PC is determined based on the cumulative operation time of the CPU, for example.

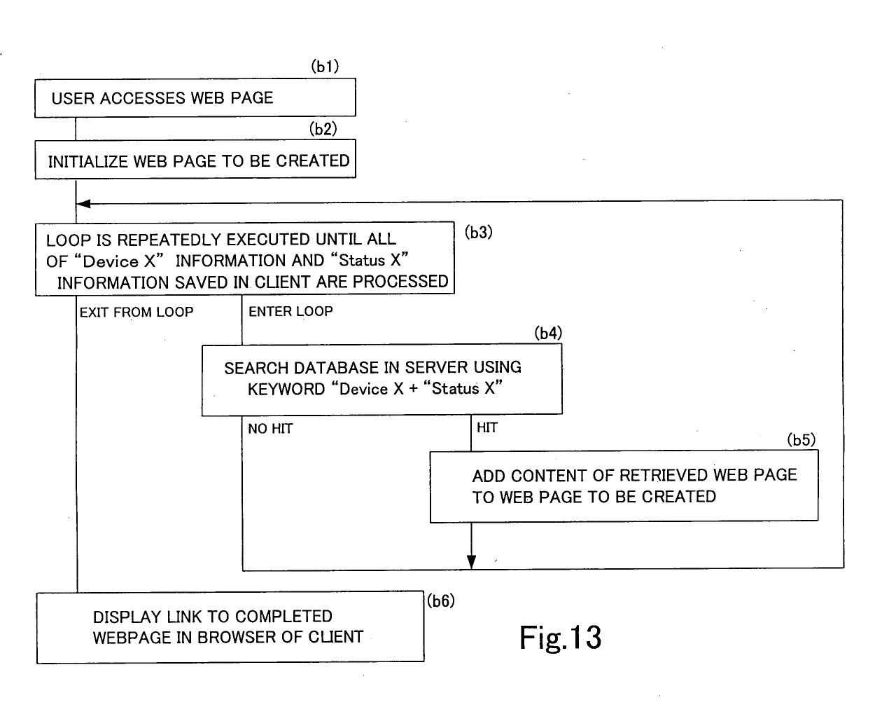

FIG. 13 shows a flow of a process executed in the server 80 shown in FIG. 7.

When the user clicks the “Open Web Page” button in the illustrative dialog box in FIG. 8 with the mouse, access to the web page whose address is shown in the dialog box is started (step b1).

Then, in the server 80, the web page to be created is initialized (step b2), and a loop from step b3 to step b5 is executed until all of the “Device X” information and “Status X” information saved in the trouble/failure database 71 in the client (user PC 70) is processed (step b3). Specifically, in step b4, the database in the server is searched using a keyword “Device X+Status X”, and if there is information associated with the keyword in the database in the server, the process continues to step b5, where the content of the retrieved web page is added to the web page to be created. The retrieved web page includes catalog information about replacements for “Device X+Status X”.

Once all of the “Device X” information and “Status X” information saved in the trouble/failure database 71 in the client (user PC 70) is processed (step b2), the process continues to step b6, where the link to the completed web page is displayed in the browser on the client (user PC 70), thereby making it possible to display the web page on the client (step b6).

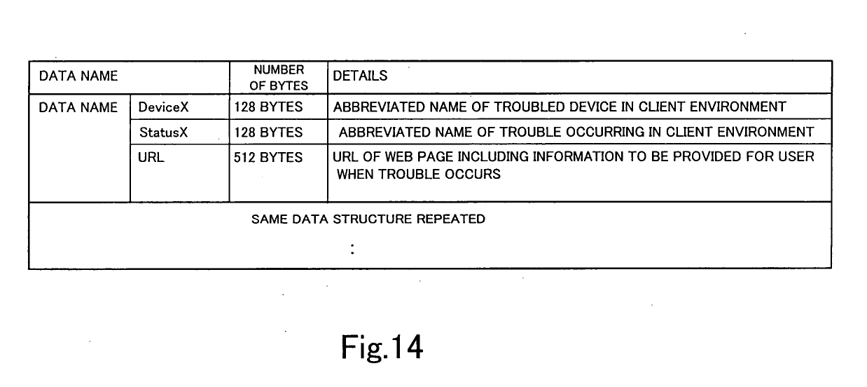

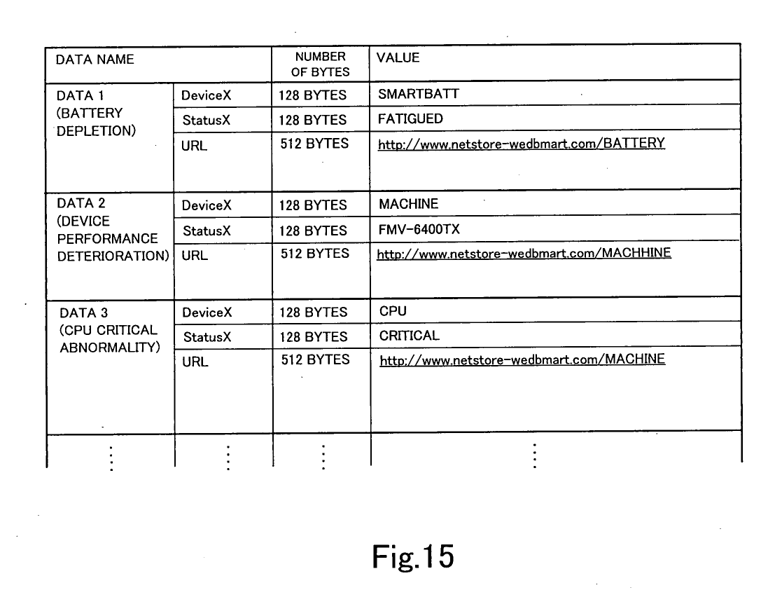

FIG. 14 shows a data structure of the information stored in the database in the server, and FIG. 15 shows specific examples of the information stored in the database.

As shown in FIG. 14, one piece of information is composed of “Device X”, “Status X” and “URL”. The “Device X” field is filled in with an abbreviated name of a troubled device in the client environment (see FIG. 11), the “Status X” field if filled in with an abbreviated name of the trouble occurring in the client environment (see FIG. 12), and the “URL” field is filled in with the URL of the web page that includes information to be provided for the user when the trouble “Status X” occurs in the “Device X”.

Specifically, for example, as for “data 1” in FIG. 15, the “Device X” field is filled in with “SMARTBATT”, the “Status X” field is filled in with “FATIGUED”, and the “URL” field is filled in with “http://www.netstore-wedbmart.com/BATTERY”.

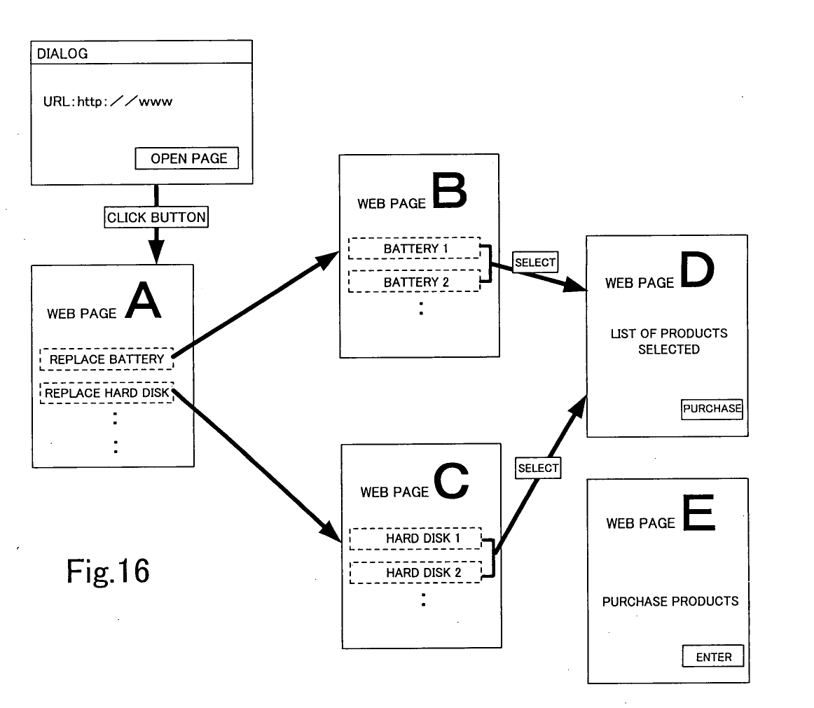

FIG. 16 shows a process flow after the dialog box is displayed.

Once the user selects the “Open Web Page” button in the dialog box displayed by the hardware monitoring program, the hardware monitoring program detects the clicking of the “Open Web Page” button, and the operating system (OS) of the user PC functions to open a particular web page (web page A, in this example), and the web page A is displayed on the display screen.

As shown in FIG. 8, since the URL of the web page A is explicitly shown in the dialog box, the user may manually open the web page A without using the “Open Web Page” button.

The web page A is created as a result of analysis, on the server, of the trouble occurring in the client machine (user PC). The web page A includes options to jump to any of a web page B and a web page C which provides replacements associated with the trouble occurring in the client machine. Since the web page A is created to address the trouble occurring in the client machine, the number and contents of the options depend on the trouble occurring in the client machine. Each option is intended to guide the user to the web page that provides replacements for the troubled device and has a function of jumping to a product offering web page. In the example shown in FIG. 16, it is assumed that troubles occur in the battery and the hard disk, and options of replacing the battery and of replacing the hard disk are displayed in the web page A.

The web pages B and C are to offer products. In each of the web pages, a list of products of one category is displayed. In the example shown in FIG. 16, the web page B is a product offering web page designed for battery replacement and displays a list of battery products. In addition, the web page C is a product offering web page designed for hard disk replacement and displays a list of hard disk products. As required, various product offering web pages to address troubles occurring in the client machine may be prepared in the same manner as the web pages B and C.

Once the user selects a product on the web page B or C, jump to a web page D occurs. The web page D displays a list of the product(s) selected on the web page B or C and prompts the user to confirm his/her selection. On this page, the user can confirm that the required product(s) has been selected without fail.

The web page D includes a purchase button. If the user having confirmed the selected product(s) clicks the purchase button, jump to a web page E occurs. The web page E is a one for accomplishing the actual product purchase procedure.

The web page E is a one for accomplishing the product purchase procedure, where the delivery destination, the payment method or the like are determined through prepared steps. Once the “Enter” button is clicked on the web page E, the information written in the web page E is transmitted to the distributor via the server 70 (see FIG. 7) for product delivery and billing.

The web pages displayed on the display screen of the user PC have been described in brief above. However, since the procedure described above is executed on the browser, the user can skip between web pages using the “forward” and “backward” functions of the browser, suspend the procedure to move another web page, or break the Internet connection during the procedure. To avoid redundancy, description of such common manipulations will be omitted.

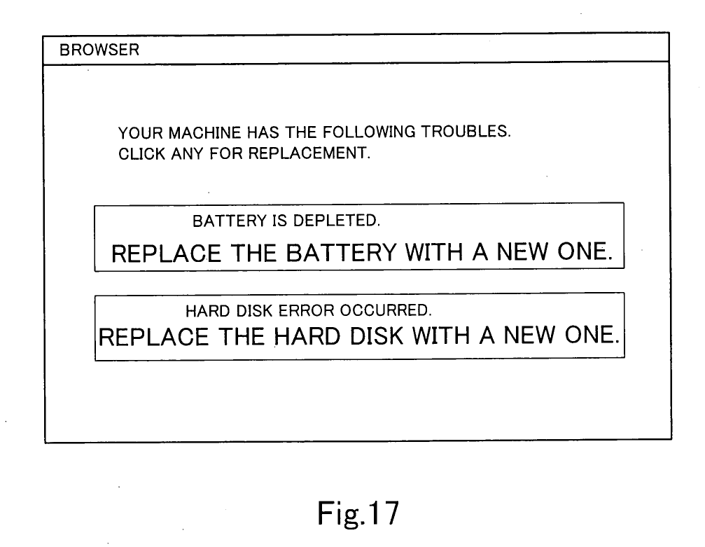

FIG. 17 shows an example of the web page A shown in FIG. 16.

In FIG. 17, “Replace battery” is an option to address depletion of the battery, and “Replace hard disk” is an option to address a seek error in the hard disk. These options are displayed on the screen in a user-friendly form as shown. However, they are actually URLs, and thus, the user can jump to a battery product offering web page by making a choice on the browser. One or more troubles may occur, and the number of options varies with the number of troubles.

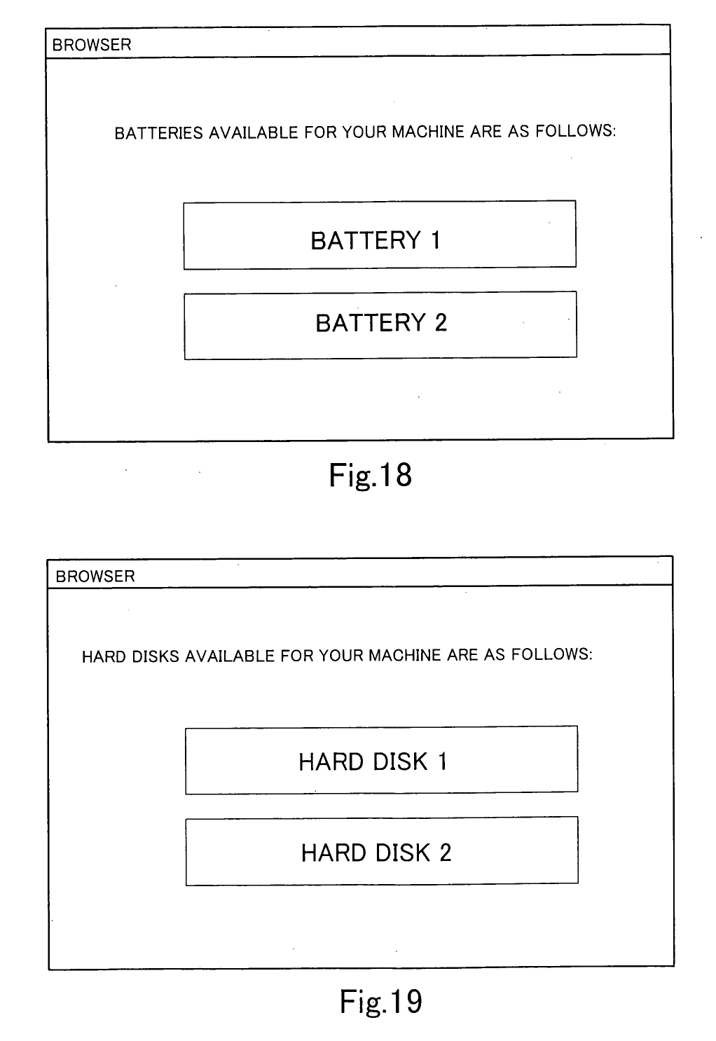

FIG. 18 shows an example of the web page B shown in FIG. 16. The web page B is a one for offering batteries, for example, and displays a catalog of products which the page offers. The details and number of the products actually offered depend on the circumstances. The user can jump to the web page D by selecting a desired product.

FIG. 19 shows an example of the web page C shown in FIG. 16. This drawing is intended to explain the case where there are a plurality of product offering pages, and the details of the web page C are similar to those of the web page C.

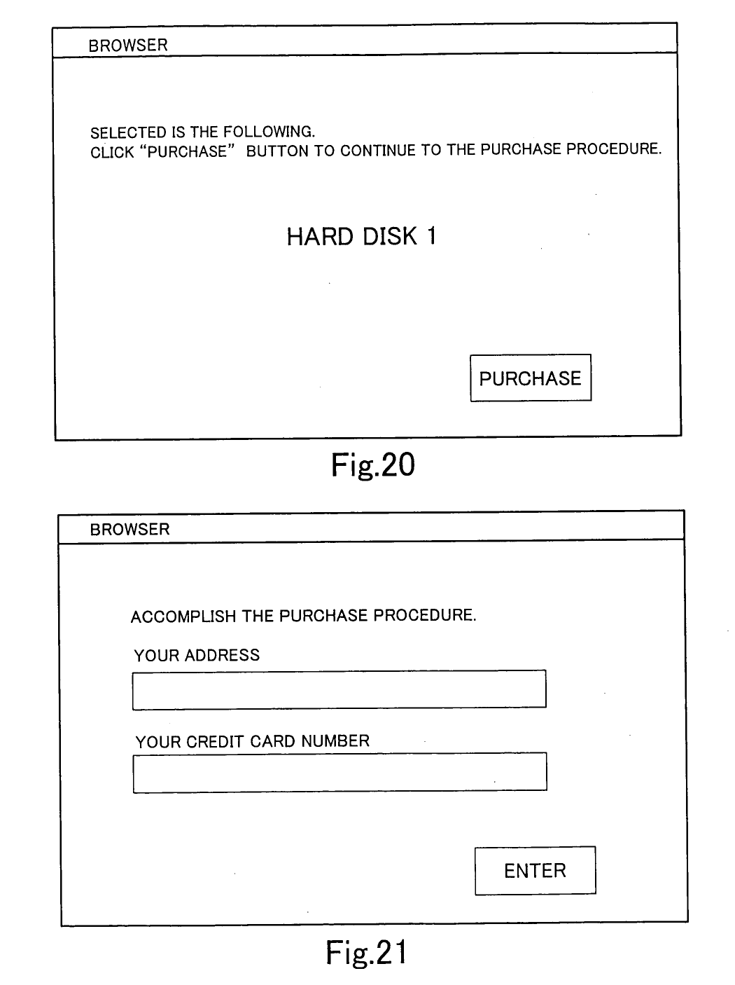

FIG. 20 shows an example of the web page D shown in FIG. 16. The webpage D is a one for displaying a list of product(s). selected by the user on the web pages B and/or C to prompt the user to confirm the selection. In this example, the user has selected a hard disk 1. The content of this web page depends on the user's selection. The web page includes a “purchase” button, and by clicking the “purchase” button, the user having confirmed the selected product(s) can jump to the web page E for accomplishing the purchase procedure.

Furthermore, a “Delete” button may be provided to delete, from the list, a product that is found, as a result of the confirmation, to have been wrongly selected. In addition, to facilitate selection of plural products, a “Solve another trouble” button to jump back to the web page A can be provided.

FIG. 21 shows an example of the web page E shown in FIG. 16. The web page E is a one that allows the user having confirmed the product(s) to be purchased on the web page D to accomplish the purchase procedure including determination of the product delivery destination, the payment method or the like.

This web page includes an entry field for the delivery destination and an entry field for the number of the credit card used for payment.

In this example, only the delivery destination field and the credit card number field, which are the essentials, are provided. However, other information entry fields may be provided according to options proposed by the distributor, such as options of designating the delivery date and time and of designating the payment method, such as cash on delivery.

Once the entries in the entry fields are completed, the user click the “Enter” button to finish the purchase procedure. Once the “Enter” button is clicked, the entries on the web page E are transmitted to the distributor via the server 80 (see FIG. 7) for product delivery and billing.

Now, another embodiment of the present invention will be described. In the following, only differences between this embodiment and the embodiments described above will be described.

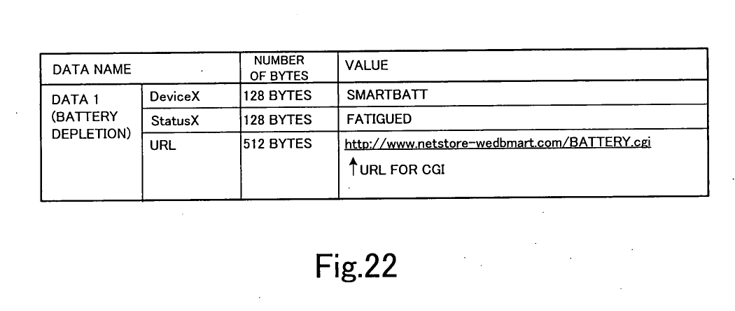

FIG. 22 shows a piece of information in the database in the server.

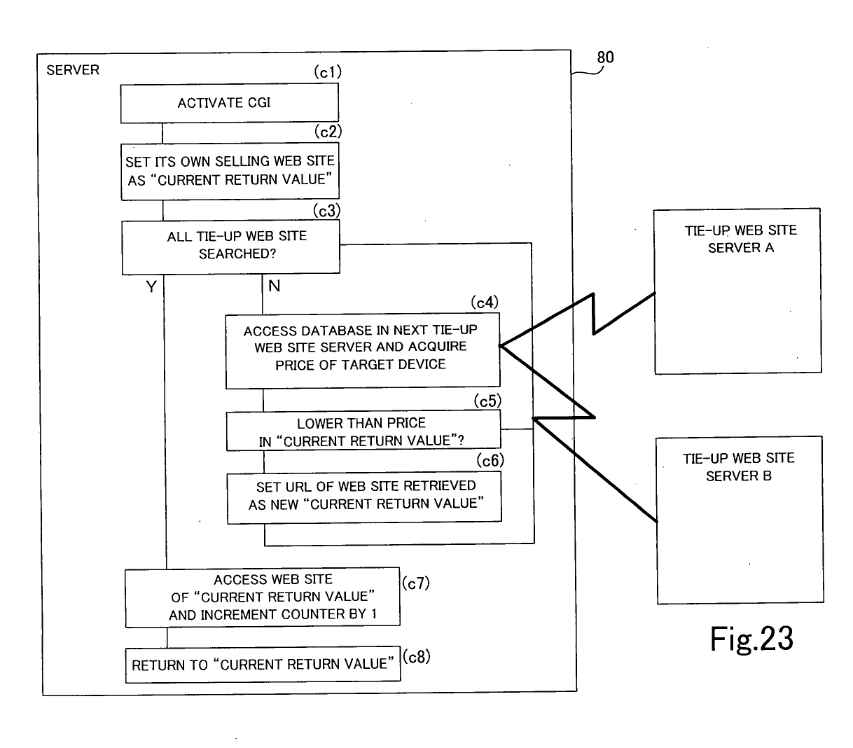

The URL shown in FIG. 22 is a one directed to CGI. If the URL directed to CGI is accessed, the server activates the CGI. The CGI is a program running on the server, which can access a database on the web to obtain information therefrom. In this example, a number of server machines having a tie-up with the server machine 80 shown in FIG. 7 (in this example, a server A and a server B as shown in FIG. 23) are connected to the Internet 90 (see FIG. 7), and the CGI accesses the servers of the tie-up web sites and retrieves the web site that sells the relevant product at the lowest price.

FIG. 23 shows a catalog selection process (see FIG. 7) executed in the server when the CGI shown in FIG. 22 is activated.

When the CGI is activated (step c1), the server sets a selling web site of its own (the company administering the server 80) as a “current return value” (step c2), and then, all the tie-up web sites are searched in the following manner (step c3). That is, once a web site is completely searched, the database in the server of a next tie-up web site is accessed, and the information about the price of the relevant device is acquired (step c4), it is determined whether the price is lower than the price assigned in the selling web site recorded as the “current return value” (step c5), and if the price assigned in the newly retrieved web site is lower than the price assigned in the web site of the “current return value”, the URL of the newly retrieved web site is set as a new “current return value” (step c6).

Once all the tie-up web sites are searched (step c3), of reference counters provided for the web sites, the reference counter associated with the web site recorded as the “current return value” is incremented by 1 (step c7), and the “current return value” is returned (step c8). In the step of creating a web page in the server 80 in FIG. 7, the “current return value”, which is return information from the CGI, is referred to, and the URL in the database in the server is replaced with the URL of the web site that sells the same device at the lowest price (the URL of the web site that sells the same device at the lowest price is displayed on the user PC). In this way, the user can purchase any device at the lowest price.

In addition, incrementing the reference counter for the web site in step C7 in FIG. 23 is intended to allow the company administering the server 80 to have a profit margin according to the count value of the reference counter from the company administrating the tie-up web site. This margin is paid because the company administrating the tie-up web site can have increased business opportunities by the URL of the tie-up web site being shown to the user.

In the embodiments described above, the client machine is the user PC (personal computer). However, the client machine according to the present invention is not limited to the so-called computers but may be any device that can be connected to a communication line such as the Internet.

For example, in recent years, household appliances that can be connected to the Internet have received general attention. For example, video cassette recorders capable of remote pre-scheduled recording via the Internet or acquiring program information from a web via the Internet, and refrigerators capable of accomplishing stock management of items contained therein and placing a purchase order via the Internet are now contemplated.

Such household appliances use a user interface using an HTTP protocol and a browser. Therefore, if the monitoring-target device is customized for each household appliance, the household appliance connected to the Internet can be made to operate as the client machine according to the present invention.

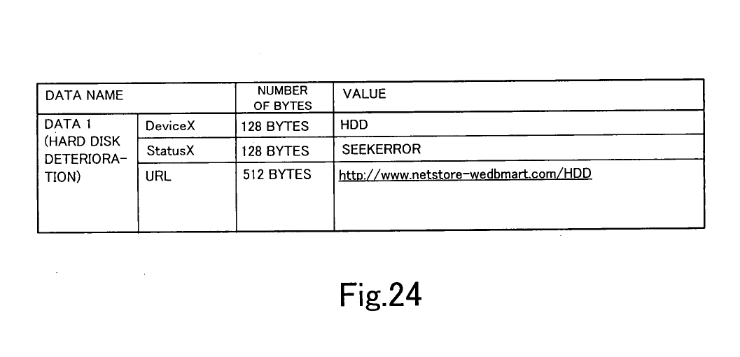

FIG. 24 shows an example of the database in the server for supporting a video cassette recorder capable of hard disk recording.

In this drawing, a URL of a web site that provides replacements for the hard disk of the video cassette recorder, in which a seek error occurs, is shown.

1. A server machine that is connected to a client machine via a communication line and provides information for the client machine, characterized in that the server machine comprises:
an information receiving section that receives hardware information that indicates the state of the hardware of the client machine via the communication line;
a catalog retrieving section that retrieves catalog information about a replacement for a part of the client machine or for the client machine itself based on said hardware information about the client machine received at said information receiving section; and
a catalog transmitting section that transmits the catalog information retrieved by said catalog retrieving section to said client machine via the communication line.

2. The server machine according to claim 1, characterized in that said information receiving section receives information about deterioration of a part of the client machine or of the client machine itself as said hardware information from said client machine, and
said catalog retrieving section retrieves catalog information about a replacement for the deteriorated part of the client machine or for the deteriorated client machine itself based on said hardware information about the client machine received at said information receiving section.

3. The server machine according to claim 1, characterized in that said server machine has a catalog database storing catalog information, and said catalog retrieving section searches the catalog database.

4. The server machine according to claim 1, characterized in that said communication line has another machine that provides catalog information connected thereto besides said server machine, and
said catalog retrieving section inquires of said other machine whether it retains desired catalog information to acquire the desired catalog information.

5. The server machine according to claim 1, characterized in that said catalog retrieving section retrieves catalog information from a plurality of locations, the catalog information including price information, and
said catalog retrieving section retrieves desired catalog information by referring to the price information in the catalog information.

6. The server machine according to claim 1, characterized in that the server machine further comprises a purchase offer receiving section that receives a purchase offer for a replacement listed in the catalog information via the communication line from the client machine to which the catalog information has been transmitted.

7. A client machine that is connected to a server machine via a communication line and receives information provided by the server machine, characterized in that the client machine comprises:
a monitoring section that monitors the client machine and acquires hardware information that indicates the state of the hardware of the client machine;
an information transmitting section that transmits the hardware information acquired by said monitoring section to said server machine via the communication line;
a catalog receiving section that receives catalog information about a replacement for a part of the client machine or for the client machine itself that is transmitted from said server machine in response to the hardware information transmitted from said information transmitting section; and
a catalog outputting section that outputs the catalog information received at said catalog receiving section.

8. The client machine according to claim 7, characterized in that the client machine further comprises a purchase offering section that conducts a purchase offering procedure for a replacement listed in the catalog information received at said catalog receiving section.

9. A server/client system having a server machine for providing information and a client machine for receiving information from the server machine, which are connected to each other via a communication line, characterized in that
said server machine comprises:
an information receiving section that receives hardware information that indicates the state of the hardware of the client machine via the communication line;
a catalog retrieving section that retrieves catalog information about a replacement for a part of the client machine or for the client machine itself based on said hardware information about the client machine received at said information receiving section; and
a catalog transmitting section that transmits the catalog information retrieved by said catalog retrieving section to said client machine via the communication line, and
said client machine comprises:
a monitoring section that monitors the client machine and acquires hardware information that indicates the state of the hardware of the client machine;
an information transmitting section that transmits the hardware information acquired by said monitoring section to said server machine via the communication line;
a catalog receiving section that receives catalog information about a replacement for a part of the client machine or for the client machine itself that is transmitted from said server machine in response to the hardware information transmitted from said information transmitting section; and
a catalog outputting section that outputs the catalog information received at said catalog receiving section.

10. A server program that is executed in a computer connected to a client machine via a communication line and makes the commuter operate as a server machine that provides information to the client machine, characterized in that the server machine makes said computer operate as a server machine comprising:
an information receiving section that receives hardware information that indicates the state of the hardware of the client machine via the communication line;
a catalog retrieving section that retrieves catalog information about a replacement for a part of the client machine or for the client machine itself based on said hardware information about the client machine received at said information receiving section; and
a catalog transmitting section that transmits the catalog information retrieved by said catalog retrieving section to said client machine via the communication line.

11. The server program according to claim 10, characterized in that said information receiving section receives information about deterioration of a part of the client machine or of the client machine itself as said hardware information from said client machine, and
said catalog retrieving section retrieves catalog information about a replacement for the deteriorated part of the client machine or for the deteriorated client machine itself based on said hardware information about the client machine received at said information receiving section.

12. The server program according to claim 10, characterized in that said catalog retrieving section retrieves catalog information from a plurality of locations, the catalog information including price information, and
said catalog retrieving section retrieves desired catalog information by referring to the price information in the catalog information.

13. The server program according to claim 10, characterized in that the server program makes said computer operate as the server machine further comprising a purchase offer receiving section that receives a purchase offer for a replacement listed in the catalog information via the communication line from the client machine to which the catalog information has been transmitted.

14. A client program that is executed in a computer connected to a server machine via a communication line and makes the computer operate as a client machine that receives information provided by the server machine, characterized in that the client program makes said computer operate as a client machine comprising:
a monitoring section that monitors the client machine and acquires hardware information that indicates the state of the hardware of the client machine;
an information transmitting section that transmits the hardware information acquired by said monitoring section to said server machine via the communication line;
a catalog receiving section that receives catalog information about a replacement for a part of the client machine or for the client machine itself that is transmitted from said server machine in response to the hardware information transmitted from said information transmitting section; and
a catalog outputting section that outputs the catalog information received at said catalog receiving section. 15. The client program according to claim 14, characterized in that the client program makes said computer operate as the client machine further comprising a purchase offering section that conducts a purchase offering procedure for a replacement listed in the catalog information received at said catalog receiving section.
